(19) United States
(12) Patent Application Publication
(10) Pub. No.: US 2014/0119284 A1
(43) Pub. Date: May 1, 2014

(54) Resources for Multi-Cell Channel State Information Feedback

(71) Applicant: Telefonaktiebolaget L M Ericsson (publ), Stockholm (SE)

(72) Inventors: Robert Baldemair, Solna (SE); Jung-Fu Cheng, Fremont, CA (US); Sorour Falahati, Stockholm (SE); Mattias Frenne, Uppsala (SE); Daniel Larsson, Vallentuna (SE)

(73) Assignee: Telefonaktiebolaget L M Ericsson (publ), Stockholm (SE)

(21) Appl. No.: 14/126,986

(22) PCT Filed: May 8, 2013
(86) PCT No.: PCT/SE2013/000068

§ 371 Date: Dec. 17, 2013

Related U.S. Application Data
(60) Provisional application No. 61/645,984, filed on May 11, 2012.

(51) Int. Cl. H04W 24/10

(52) U.S. Cl. CPC H04W 24/10
USPC 370/328

(57) ABSTRACT

User Equipment reports single-cell or multi-cell channel state information to a base station on a Physical Uplink Control Channel (PUCCH) Format 3 (PF 3) resource. The PF 3 resource selected depends on whether ACK/NACK needs to be reported simultaneously. Different coding and/or scrambling and/or interleaving schemes are used depending on whether ACK/NACK bits are present, as well as the number of ACK/NACK and/or CSI bits. Resource compatibility is maintained independently of the details of coding, interleaving, or scrambling—that is, all formats can be orthogonally multiplexed onto the same time-frequency resources. The format used for CSI only is PF 3c whereas the format used for CSI and ACK/NACK is PF 3b. PUCCH Formats 3b and 3c may be further differentiated depending on whether a CSI from a single or multiple cells are reported, or from which cells (PCell, SCell) an ACK/NACK is reported.

### TECHNICAL FIELD

The present Invention relates generally to wireless communication networks, and in particular to a system and method for Channel State information feedback in LTE carrier aggregation.

### BACKGROUND

The 3^{rd} Generation Partnership Project (3GPP) oversees and governs 3^{rd} Generation (3G) networks, including 3G Long Term Evolution (LTE) networks. 3G LTE provides mobile broadband to User Equipment (UE) within the 3G LTE network at higher data rates than generally available with other networks. For example, the air interface for 3G LTE, Evolved Universal Mobile Telecommunication System (UMTS) Terrestrial Radio Access Network (E-UTRAN), utilizes multi-antenna and multi-user coding techniques to achieve downlink data rates of 100 s of Mbps and uplink data rates of 10 s of Mbps.

LTE uses Orthogonal Frequency Division Multiplexing (OFDM) in the downlink and Discrete Fourier Transform (DFT)-spread OFDM in the uplink. The basic LTE downlink physical resource can thus be seen as a time-frequency grid as illustrated in FIG. 1, where each resource element corresponds to one OFDM subcarrier during one OFDM symbol interval. In the time domain, LTE downlink transmissions are organized into radio frames of 10 ms, each radio frame comprising ten equally-sized subframes of length T_{subframe}=1 ms, as shown in FIG. 2. Furthermore, the resource allocation in LTE is typically described in terms of resource blocks, where a resource block corresponds to one slot (0.5 ms) in the time domain and 12 contiguous subcarriers in the frequency domain. Resource blocks are numbered in the frequency domain, starting with 0 from one end of the system bandwidth.

Downlink transmissions are dynamically scheduled, e.g., in each subframe the base station transmits control information about to which terminals data is transmitted and upon which resource blocks the data is transmitted. In the current downlink subframe. This control signaling is typically transmitted in the first 1, 2, 3 or 4 OFDM symbols in each subframe. A downlink system with 3 OFDM symbols for control signaling is illustrated in FIG. 3.

LTE uses Hybrid-Automatic Repeat Request (Hybrid-ARQ, or HARQ), where, after receiving downlink data in a subframe, the terminal attempts to decode it and reports to the base station whether the decoding was successful with an acknowledgement (ACK) or not successful with a negative acknowledgement (NACK). In case of an unsuccessful decoding attempt, the base station can retransmit the erroneous data.

Uplink control signaling, or L1/L2 control information, from the terminal to the base station includes: HARQ acknowledgements for received downlink data; terminal reports related to the downlink channel conditions, called Channel State Information (CSI) reports, used as assistance for the downlink scheduling; and scheduling requests, indicating that a mobile terminal needs uplink resources for uplink data transmissions.

if the mobile terminal has not been assigned an uplink resource for data transmission, the L1/L2 control information (channel state reports, HARQ acknowledgments, and scheduling requests) is transmitted using uplink resources (resource blocks) specifically assigned for uplink L1/L2 control on the Physical Uplink Control CHannel (PUCCH). As illustrated in FIG. 4, these resources are located at the edges of the total available cell bandwidth. Each such resource comprises 12 subcarriers (one resource block) within each of the two slots of an uplink subframe. In order to provide frequency diversity, these frequency resources use frequency hopping on the slot boundary, e.g., one “resource” comprises 12 subcarriers at the lower part of the spectrum during the first slot of a subframe and an equally sized resource at the upper part of the spectrum during the second slot of the subframe, or vice versa. If more resources are needed for the uplink L1/L2 control signaling, e.g., in case of very large overall transmission bandwidth supporting a large number of users, additional resource blocks can be assigned next to the previously assigned resource blocks.

There are two primary reasons for locating the PUCCH resources at the edges of the overall available spectrum. First, together with the frequency hopping described above, this maximizes the frequency diversity experienced by the control signaling. Second, assigning uplink resources for the PUCCH at other positions within the spectrum, e.g., not at the edges, would fragment the uplink spectrum, making it impossible to assign very wide transmission bandwidths to a single mobile terminal and still retain the single-carrier property of the uplink transmission.

The bandwidth of one resource block during one subframe is too large for the control signaling needs of a single terminal. Therefore, to efficiently exploit the resources set aside for control signaling, multiple terminals can share the same resource block by some form of orthogonal spreading. Three formats for PUCCH have been defined. They are briefly summarized as:
PUCCH Format 1 (PF 1): Used for scheduling request transmissions,
PUCCH Format 1a/1 b (PF 1a/1b): Used for the transmission of one ACK/NACK bit (1a) or two ACK/NACK bits (1b). In Carrier Aggregation (CA) PF 1a/1b can be used together with channel selection to Increase the number of HARQ ACK/NACK bits that can be transported.
PUCCH Format 2 (PF 2): Used for the transmission of CSI bits.
PUCCH Format 2a/2b (PF 2a/2b): Used for the transmission of CSI bits together with one ACK/NACK bit (2a) or two ACK/NACK bits (2b).
PUCCH Format 3 (PF 3): Used in carrier aggregation and Time Division Duplexing (TDD) to transmit HARQ ACK/NACK bits from multiple cells and/or subframes. The payload capacity of PF 3 is 11 bits with standard Reed-Muller encoding and 21 bits with dual Reed-Muller encoding. Recently it has been proposed to use a similar format to transmit CSI reports together with multi-cell ACK/NACK resources or only multi-cell CSI reports, where “similar” means a scheme that can be orthogonally multiplexed onto the same resources as PF 3, but may use different processing of the payload.
   The PUCCH Formats 1 and 2 are described in greater detail:

### PUCCH Format 1

PUCCH Format 1 is used for Hybrid-ARQ acknowledgements and, if necessary, scheduling requests. Hybrid-ARQ acknowledgements are used to acknowledge the reception of one (or two in the case of spatial multiplexing) transport blocks in the DL. An ACK is reported to Indicate successful decoding; a NACK is reported if the downlink transmission was received with errors; and no Hybrid-ARQ is reported when the terminal did not receive any assignment. The ACK/NACK can be one or two bits. A single ACK/NACK bit, related to one transport block, is used to generate a BPSK symbol, and is transmitted on PUCCH Format 1a. In the case of spatial multiplexing, two ACK/NACK bits are used to generate a QPSK symbol, which is transmitted on PUCCH Format 1 b.

Scheduling requests are used to request UL transmission resources from the base station. Unlike ACK/NACK indicators, no explicit information bit is transmitted by the scheduling request; instead, the information is conveyed by the presence (or absence) of energy on the corresponding PUCCH.

To multiplex multiple terminals onto PUCCH, each terminal is assigned a different orthogonal phase rotation of a cell-specific, length-12 frequency-domain sequence (equivalent to a cyclic sift in the time domain). To provide for an even larger number of terminals to share the PUCCH, the BPSK/QPSK symbol for a terminal is multiplied by a length-4 orthogonal cover sequence; this product then modulates the terminal's assigned rotated length-12 sequence. A PUCCH Format 1 resource, used to transmit either an ACK/NACK and/or a scheduling request, is represented by a scalar Index, which identifies the phase rotation and orthogonal cover sequence.

The phase rotation and orthogonal cover sequence provides Intra-cell orthogonally between all terminals sharing the same time-frequency resource on PUCCH. To provide immunity to Inter-cell interference (which arises as the sequences are not orthogonal between different cells), the phase rotation of the sequence used in a cell varies on a symbol-by-symbol basis in a slot according to a hopping pattern derived from the physical-layer cell identity. Additionally, slot-level hopping is applied to the orthogonal cover and phase rotation to further randomize the interference.

### PUCCH Format 2

PUCCH Format 2 is used for Channel State Information (CSI) reports, which provide the base station information on the quality of the received channel, to facilitate channel-dependent scheduling. A CSI can comprise multiple bits per subframe. Because PF 1 is limited to two bits, a different format definition is necessary to transmit CSI.

In PF 2, QPSK modulated CSI data modulate per-terminal assigned orthogonal phase rotation of the cell-specific, length-12 frequency-domain sequence as in PF 1, but without orthogonal spreading. Each rotated sequence can be used for one PF 2 instance or three PF 1 instances. PF 2a is used to transmit CSI together with one ACK/NACK bit; PF 2b is used to transmit CSI together with two ACK/NACK bits (e.g., for spatial multiplexing).

The LTE Rel-8 standard has been standardized, supporting bandwidths up to 20 MHz. However, in order to meet the international Mobile Telecommunications (IMT)-Advanced requirements, 3GPP also recently finalized LTE Rel-10, which describes supporting bandwidths larger than 20 MHz. One important requirement on LTE Rel-10 is to assure backward compatibility with LTE Rel-8. This should also Include spectrum compatibility, which implies that an LTE Rel-10 carrier wider than 20 MHz should appear as a number of LTE carriers to an LTE Rel-8 terminal. Each such carrier can be referred to as a cell. In particular for early LTE Rel-10 deployments it can be expected that there will be a smaller number of LTE Rel-10-capable terminals compared to many LTE legacy terminals. Therefore, it is necessary to also assure an efficient use of a wide carrier for legacy terminals, e.g., that it is possible to implement carriers where legacy terminals can be scheduled in all parts of the wideband LTE Rel-10 carrier. The straightforward way to obtain this would be by means of Carrier Aggregation (CA). CA implies that an LTE Rel-10 terminal can receive multiple cells, where the cells have, or at least the possibility to have, the same structure as a Rel-8 carrier. CA is Illustrated in FIG. 5Error!Reference source not found.

The number of aggregated cells, as well as the bandwidth of the individual cells, may be different for uplink and downlink. A symmetric configuration refers to the case where the number of downlink and uplink cells is the same, whereas an asymmetric configuration refers to the case that the number of downlink and uplink cells is different. It is important to note that the number of cells configured in the network may be different from the number of cells seen by a terminal. A terminal may for example support more downlink cells than uplink cells, even though the network offers the same number of uplink and downlink cells.

During Initial access, a LTE Rel-10 terminal behaves similar to an LTE Rel-8 terminal. Upon successful connection to the network a terminal may—depending on Its own capabilities and the network—be configured with additional downlink (DL) cells and corresponding uplink (UL) cells. Configuration is based on Radio Resource Control (RRC).

Scheduling of a cell is done on the Physical Downlink Control CHannel (PDCCH) or enhanced PDCCH (ePDCCH) via downlink assignments. Control Information on the PDCCH or ePDCCH Is formatted as a Downlink Control Information (DCI) message. In Rel-8 a terminal only operates with one DL cell and one UL cell, the association between the DL assignment, the UL grants, and the corresponding DL and UL cells Is therefore clear. In Rel-10 two modes of CA needs to be distinguished. The first case is very similar to the operation of multiple Rel-8 terminals, where a DL assignment or UL grant contained in a DCI message transmitted on a DL is either valid for the DL cell itself or for the UL associated with the DL cell (either via cell-specific or terminal specific linking). A second case augments a DCI message with the Carrier Indicator Field (CIF). A DCI containing a DL assignment with a CIF Is valid for the DL cell Indicted with CIF, and a DCI containing an UL grant with a CIF is valid for the UL associated with the Indicated DL cell.

One of the aggregated cells—the primary cell (PCell)—is special, compared to secondary cells (SCell). The UL of the PCell carries PUCCH. In the DL radio link monitoring is only defined for the PCell, e.g., a radio connection is reset if the terminal loses DL PCell connectivity but not if the terminal loses DL SCell connectivity.

From a LIE perspective, both symmetric and asymmetric uplink/downlink configurations are supported. For some of the configurations, one may consider the possibility to transmit the uplink control information on multiple PUCCH or UL of multiple cells. However, this option is likely to result in higher UE power consumption and a dependency on specific UE capabilities. It may also create implementation issues due to Inter-modulation products, and would lead to generally higher complexity for implementation and testing.

Therefore, the transmission of the PUCCH should have no dependency on the uplink/downlink configuration, e.g. all uplink control information for a UE is transmitted on a single UL. This is the UL of the semi-statically configured primary cell PCell (also referred to as the “anchor carrier”).

Terminals only configured with a single cell (one DL and the associated UL, which is then the PCell) operate with dynamic ACK/NACK on PUCCH according to Rel-8. The first Control Channel Element (CCE) used to transmit PDCCH for the DL assignment determines the dynamic ACK/NACK resource on Rel-8 PUCCH.

Terminals configured with multiple DL cells use PF 3 or PF 1a/1b, together with channel selection, to provide HARQ feedback from all scheduled DL cells. Which of these formats is used is RRC configured.

Even a terminal configured with multiple DL cells, which receives only a PCell assignment, uses Rel-8 PUCCH. A terminal configured with multiple DL cells which receives multiple DL assignments, or at least one DL SCell assignment, uses PF 3 or PF 1 a/1b together with channel selection. A terminal is configured with multiple resources for PF 3 or channel selection to Increase scheduling flexibility and avoid PUCCH collisions. Which PF 3 or channel selection resource to use is indicated in each SCell DL assignment by the ACK/NACK Resource Indicator (ARI); HARQ feedback of configured cells for which no DL assignment is received is set to NACK.

If reporting of HARQ feedback and CSI feedback collides, different behaviors can be configured. In case the terminal reports ACK/NACK with Rel-8 PUCCH it can be configured to drop CSI and report only ACK/NACK or to use PF 2a/2b and report CSI together with ACK/NACK. If CSI from multiple cells should be reported it drops all but one CSI report according to a priority rule.

If the terminal reports ACK/NACK using PF 3 it drops all CSI reports and only reports ACK/NACK. Dropped CSI reports never reach the base station, which implies that the base station has only older (maybe even outdated) CSI reports from cells which CSI reports have been dropped. Outdated or old CSI reports have a negative Impact on DL throughput.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary Is not an extensive overview of the disclosure and is not intended to identify key/critical elements of embodiments of the invention or delineate the scope of the invention. The sole purpose of this summary is to present some concepts disclosed herein in a simplified form as a prelude to the more detailed description that is presented later

According to one or more embodiments described and claimed herein, a terminal reports single-cell or multi-cell CSI on a PUCCH Format 3 resource. Depending on whether ACK/NACK needs to be reported simultaneously, a different PUCCH Format 3 resource can be selected. The presence of ACK/NACK bits also impacts the processing of the payload, where different coding and/or scrambling and/or Interleaving scheme is used depending on whether ACK/NACK bits are present. Also the number of ACK/NACK and/or CSI bits impacts coding and/or scrambling and/or Interleaving. However, independent of the details of coding, Interleaving, or scrambling, resource compatibility Is maintained that is, all formats can be orthogonally multiplexed onto the same time-frequency resources. The format used for CSI only is PUCCH Format 3c (PF 3c) whereas the PUCCH Format used for CSI and ACK/NACK is PUCCH Format 3b (PF 3b). PUCCH Formats 3b and 3c may be further differentiated depending on whether a CSI from a single or multiple cells are reported, or from which cells (PCell, SCell) an ACK/NACK is reported.

One embodiment relates to a method, by UE operative in a wireless communication network supporting carrier aggregation, of transmitting uplink channel state Information on a PUCCH. The PCell and any SCell assignments are determined. Any DL transmissions on PCell or SCell(s) are decoded and any corresponding Hybrid-ARQ acknowledgements are generated. If the UE has no Hybrid-ARQ acknowledgement to report, CSI is reported on a CSI resource using PUCCH Format 3c. If the UE has a Hybrid-ARQ acknowledgement only for a received PCell DL transmission, the Hybrid-ARQ acknowledgement is reported on a CSI_PCell_AN resource using PUCCH Format 3b. If the LIE has a Hybrid-ARQ acknowledgement for one or more received SCell DL transmissions, the Hybrid-ARQ acknowledgement is reported on an ARI resource using PUCCH Format 3b.

Another embodiment relates to a method, by a base station operative in a wireless communication network supporting carrier aggregation, of processing UL channel state information reports received from a UE, on a PUCCH. The PCell and any SCell assignments for the UE are determined. Any corresponding expected Hybrid-ARQ acknowledgements are determined, from downlink transmissions to the UE. If the base station expects no Hybrid-ARQ acknowledgement from the UE, a channel state information report on a CSI resource using PUCCH Format 3c is processed. If the base station expects a Hybrid-ARQ acknowledgement only for a PCell DL transmission, a Hybrid-ARQ acknowledgement on a CSI_PCell_AN resource using PUCCH Format 3b is processed. If the base station expects a Hybrld-ARQ acknowledgement for one or more SCell DL transmissions, a Hybrid-ARQ acknowledgement on an ARI resource using PUCCH Format 3b is processed.

Yet another embodiment relates to UE operative in a wireless communication network supporting carrier aggregation. The UE Includes a transceiver, memory, and a controller operatively connected to the transceiver and the memory. The controller is operative to determine the PCell and any SCell assignments, and decode any DL transmissions on PCell or SCell(s) and generate any corresponding Hybrld-ARQ acknowledgements. If the UE has no Hybrid-ARQ acknowledgement to report, the controller is operative to cause the transceiver to report channel state Information on a CSI resource using PUCCH Format 3c. If the UE has a Hybrid-ARQ acknowledgement only for a received PCell DL transmission, the controller is operative to cause the transceiver to report the Hybrld-ARQ acknowledgement on a CSI_PCell_AN resource using PUCCH Format 3b. If the UE has a Hybrid-ARQ acknowledgement for one or more received SCell DL transmissions, the controller Is operative to cause the transceiver to report the Hybrid-ARQ acknowledgement on an ARI resource using PUCCH Format 3b.

Still another embodiment relates to a base station operative in a wireless communication network supporting carrier aggregation. The base station includes communication circuits operative to communicate with other network nodes, a transceiver, memory, and a controller operatively connected to the communication circuits, the transceiver and the memory. The controller is operative to determine the PCell and any SCell assignments for the UE, and determine, from downlink transmissions to the UE, any corresponding expected Hybrid-ARQ acknowledgements. If the base station expects no Hybrid-ARQ acknowledgement from the UE, the controller is operative to process a channel state information report on a CSI resource using PUCCH Format 3c. If the base station expects a Hybrid-ARQ acknowledgement only for a PCell DL transmission, the controller is operative to process a Hybrid-ARQ acknowledgement on a CSI_PCell_AN resource using PUCCH Format 3b. If the base station expects a Hybrid-ARQ acknowledgement for one or more SCell DL transmissions, the controller is operative to process a Hybrid-ARQ acknowledgement on an ARI resource using PUCCH Format 3b.

### BRIEF DESCRIPTION OF THE DRAWINGS

FIG. 1 is a time-frequency grid representative of an exemplary LTE downlink physical resource.

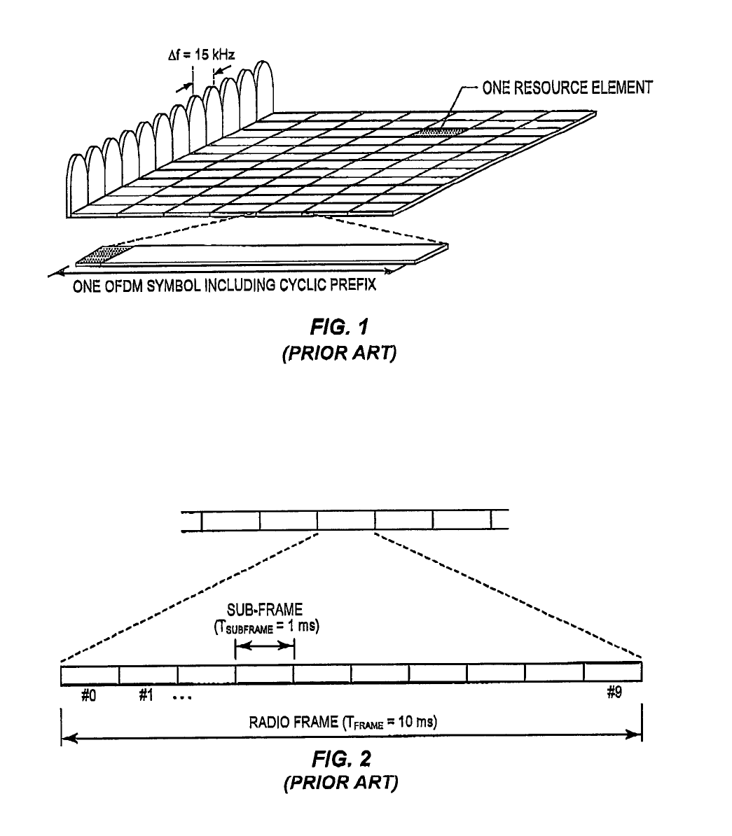

FIG. 2 is a diagram of the LTE time-domain structure.

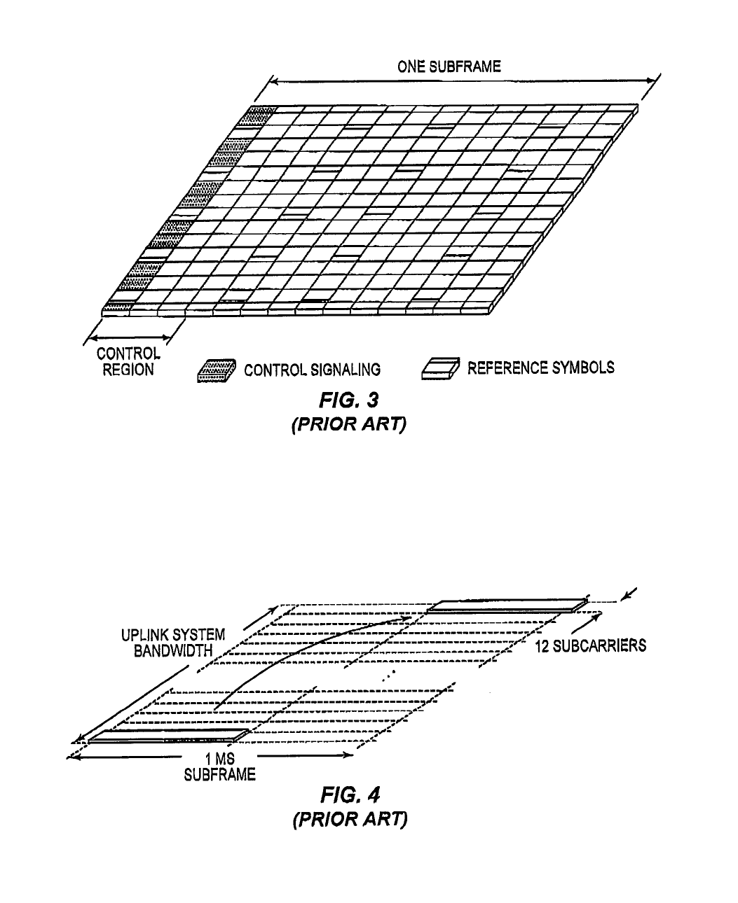

FIG. 3 is a diagram of an exemplary downlink subframe.

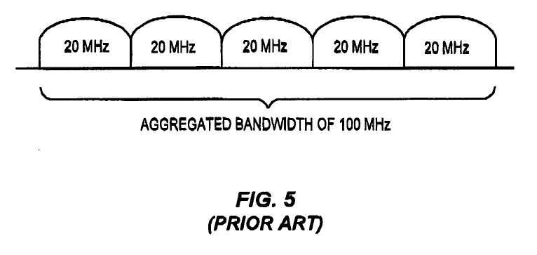

FIG. 4 is a diagram of an exemplary uplink L1/L2 control signal transmission on PUUCH.

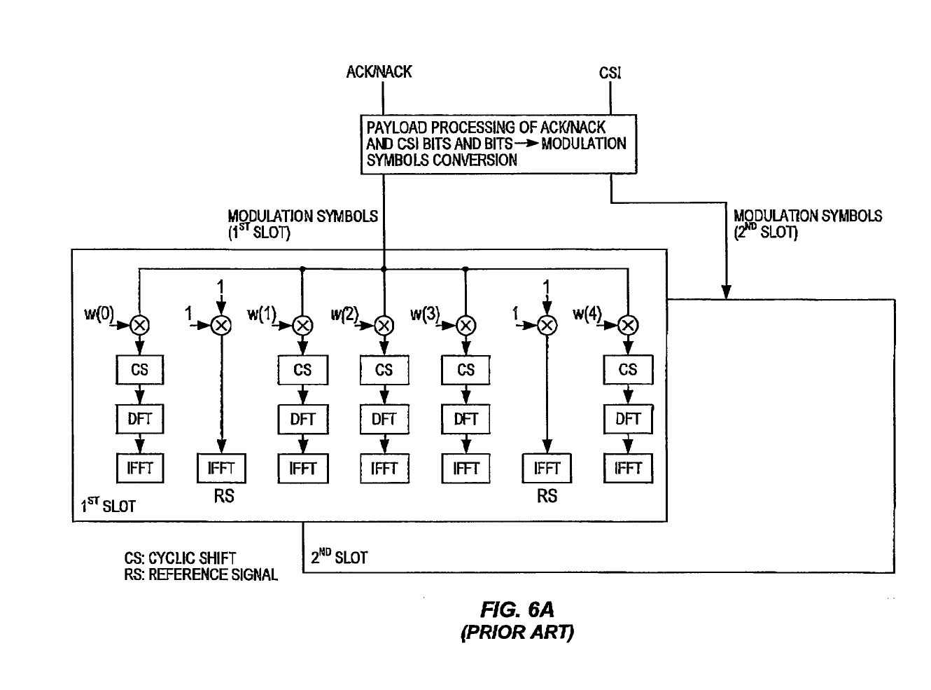

FIG. 5 is a frequency diagram of carrier aggregation.

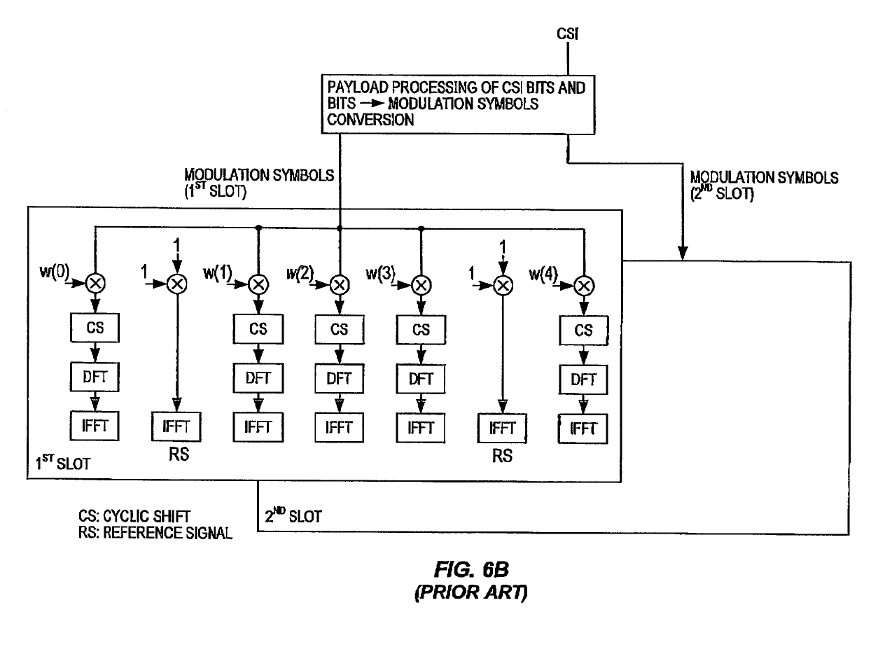

FIGS. 6a and 6b are flow graphs depicting PUCCH Format 3b and 3c processing according to embodiments of the present invention.

FIGS. 7a and 7b are flow graphs depicting PUCCH Formats 3b and 3c according to embodiments of the present invention.

FIG. 8 is a flow diagram of a method of processing by a UE.

FIG. 9 is a flow diagram of a method of processing by a base station.

FIG. 10 is a functional block diagram of processing circuits configured to implement the flow diagram of FIG. 8 and/or FIG. 9.

FIG. 11 is a flow diagram of a method of ambiguity avoidance.

FIG. 12 is a functional block diagram of processing circuits configured to implement the flow diagram of FIG. 11.

FIG. 13 is a functional block diagram of a base station.

FIG. 14 is a functional block diagram of a UE.

### DETAILED DESCRIPTION

With the advent of carrier aggregation, the need arises for a terminal to feedback multiple Hybrid-ARQ acknowledgement bits, one (or two) for each DL component carrier on which it receives data. While PF 1 can be used with resource selection to transmit up to four ACK/NACK bits, this is not an efficient solution for more than four bits.

PUCCH Format 3 is based on DFT-precoded OFDM. ACK/NACK bits and an optional scheduling request bit are concatenated and block coded using one or two Reed-Muller codes. The coded bits are scrambled using a cell-specific scrambling sequence to randomize inter-cell Interference. The resulting 48 bits are QPSK modulated and DFT-precoded, and 12 QPSK symbols are transmitted in each PUCCH slot. Five of seven OFDM symbols per slot are available for control information bits (two transmit reference signals). A cyclic shift of the 12 inputs to the DFT, varying between OFDM symbols in a cell-specific manner, is applied to the block of 12 QPSK symbols prior to DFT precoding, to further randomize inter-cell interference.

Each of the five OFDM symbols per slot is multiplied by one element of a length-5 orthogonal cover code sequence. This allows up to five terminals to share the same resource-block pair for PF 3. Different length-5 sequences are used in the two PUCCH slots.

A PF 3 resource can be represented by a single Index, from which the orthogonal sequence and the resource-block number can be derived. A terminal can be configured with four different PF 3 resources; these are assigned in a scheduling assignment, allowing the scheduler to avoid PUCCH collisions by assigning different resources to different terminals. Resources cannot be shared between PF 3 and PF 1/2.

According to embodiments of the present invention, PUCCH Format 3 resources are defined to report ACK/NACK and/or CSI according to Table 1.

TABLE 1
PUCCH Format 3 and resources used for CSI and ACK/NACK reporting

| | | | At least |
|---|---|---|---|
| | No | Only PCell | one SCell |
| | ACK/NACK | ACK/NACK | ACK/NACK |
| single-cell CSI | PF 3c, CSI | PF 3b, CSI_PCell_AN | PF 3b, ARI |
| multi-cell CSI | PF 3c, CSI | PF 3b, CSI_PCell_AN | PF 3b, ARI |

Whether a terminal should use PF 3b and PF 3c to report ACK/NACK and/or CSI Is RRC configured.

The PUCCH resource labelled “CSI” Is semi-statically configured. It can be a resource on its own or it can coincide with one of the four resources already configured for PF 3 ACK/NACK feedback. It is possible that this resource Is always one of the 4 already configured resources—e.g. the first. In this case, no extra signalling is required to configure this resource.

The PUCCH resource labelled “CSI_PCell_AN” is semi-statically configured. It can be a resource on Its own or it can coincide with one of the four resources already configured for PF 3 ACK/NACK feedback or it can coincide with resource “CSI”. It is possible that this resource is always one of the four already configured resources—e.g. the first. In this case, no extra signalling is required to configure this resource. It is possible that this resource is always the same as the “CSI” resource; In this case no extra signalling Is required to configure this resource.

The “ARI” resource Is the PF 3 resource which is indicated in the SCell DL assignment.

In the case that the terminal has only single-cell CSI or single-cell CSI together with PCell ACK/NACK to report, it could also use PF 2/2a/2b. However, because for the other cases it has to use a PF 3 resource anyway, it would be a waste of resources if a terminal needs to be configured with both PF 2/2a/2b and PF 3 resources.

Even a terminal that uses PF 1a/1b with channel selection to report multi-cell ACK/NACK could be configured with the above outlined reporting mode and resources to enable CSI reporting on PF 3 resources.

### Error Cases

PDCCH signalling Is not 100% reliable. It is possible that a terminal is scheduled on a cell but does not receive the assignment. For example, a terminal could be scheduled on the PCell and an SCell and is expected to report CSI and ACK/NACK on the “ARI” resource. However, since the terminal did not receive the SCell assignment it reports CSI and ACK/NACK on the “CSI_PCell_AN” resource.

### Terminal Scheduled on PCell Only, and PCell+SCell

If the terminal receives the PCell assignment it should report CSI on the “CSI_PCell_AN” resource using PF 3b. If it misses the PCell assignment it will use the “CSI” resource instead with PF 3c.

If the “CSI” resource and the “CSI_PCell_AN” resource are different, the base station has to attempt to decode both resources and choose the resource which delivers the better decoding metric. Based on that, the base station also knows if PCell assignment has been missed or not. On the “CSI” resource the base station uses PF 3c, whereas on the “CSI_PCell_AN” resource the base station uses PF 3b.

If “CSI” and “CSI_PCell_AN” resource are the same, the base station does not know whether to use PF 3b or PF 3c. Resolution of this ambiguity is discussed below.

If the terminal receives all assignments—e.g., PCell and one or more SCells—it will use PF 3b on the “ARI” resource.

If the terminal has also been scheduled on the PCell but misses the PCell assignment, it will still use the same resource and format. It will set the ACK/NACK bits for the non-received assignment to NACK (as in Rel-10).

If the terminal misses some SCell assignments but at least receives one SCell assignment, it will still use the same resource and format. It will set the ACK/NACK bits for the non-received assignment to NACK (as in Rel-10).

If the terminal misses all SCell assignments but receives a PCell assignment, it will use PF 3b on the “CSI_PCell_AN” resource. The terminal will set the ACK/NACK bits for the non-received assignment to NACK (as in Rel-10).

If the terminal misses all SCell assignments and also receives no PCell assignment (not scheduled or missed), it will use PF 3c on the “CSI” resource.

The base station must monitor the “ARI” resource (at least one SCell is received), the “CSI_PCell_AN” resource (only if PCell is scheduled, this resource would be used if all SCells assignments are missed but PCell assignment is received), and the “CSI” resource (no assignment is received).

The base station assumes, for decoding, the PF 3c on the “CSI” resource and the PF 3b on “CSI_PCell_AN” and “ARI” resource. If the CSI resource coincides with any or both of the “CSI_PCell_AN” and “ARI” resource, the base station does not know which format to use for decoding. Resolution of this ambiguity is discussed below.

### Avoiding Ambiguity

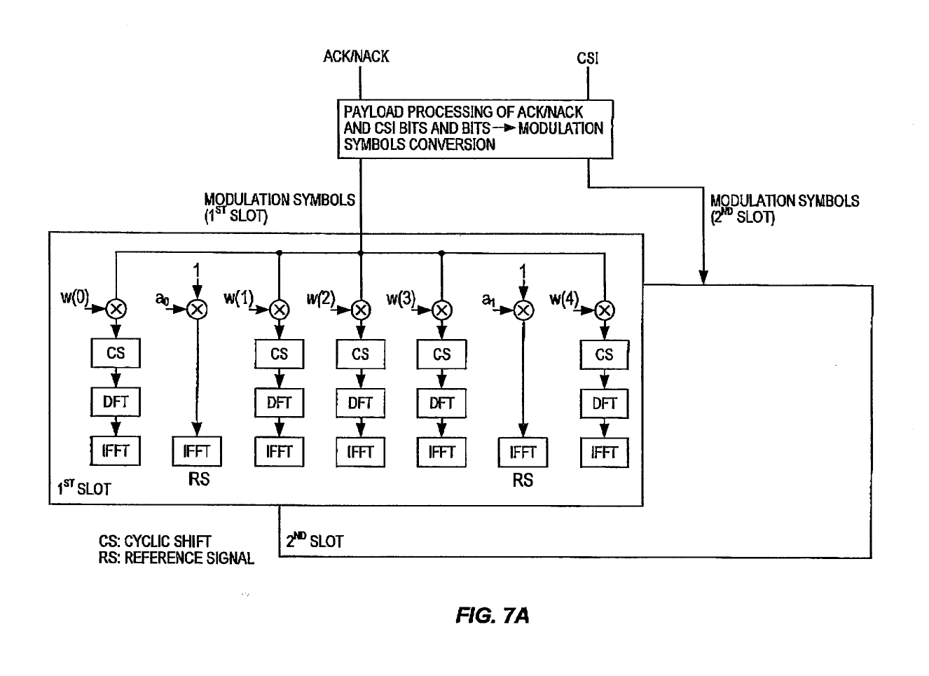

FIG. 6a depicts the processing for PUCCH Format 3b, and FIG. 6b depicts the same for PF 3c. Both formats are based on PF 3 and use the same spreading sequences for reference signal modulation, e.g. [1 1]. The payload processing is different.

If the base station does not know which format has been used, it has to test both formats. However, in many circumstances the decoding of both formats will deliver “valid” bit sequences for ACK/NACK and/or CSI, and the base station cannot tell which format has been used, and therefore also cannot tell if the bit represents an ACK/NACK and/or a CSI.

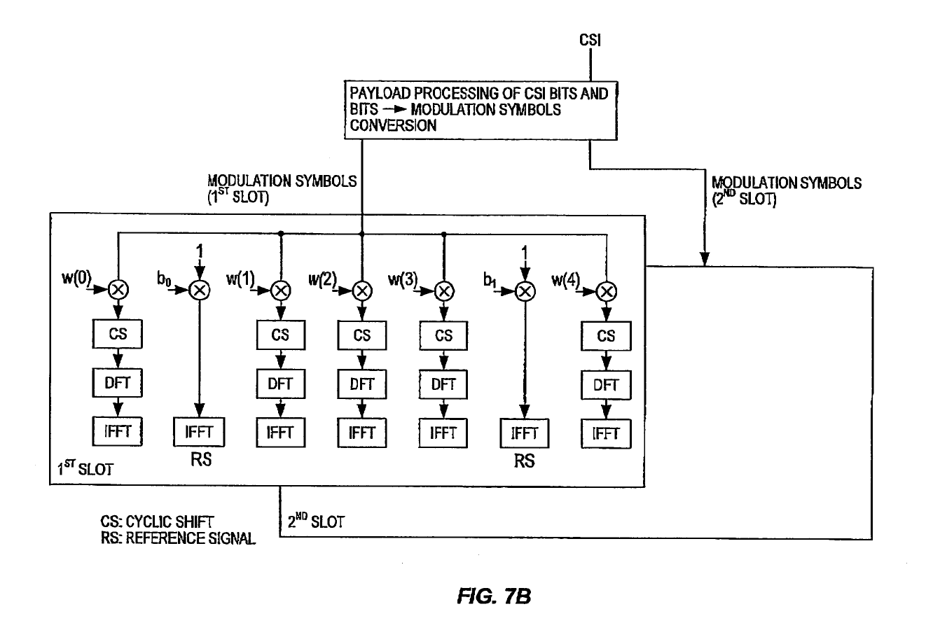

FIGS. 7a and 7b depict modifications to FIGS. 6a and 6b, respectively, where different spreading codes are used to modulate reference signals. PF 3b, depicted in FIG. 7a, uses the sequence a to modulate (spread) the reference signals, and PF 3c, depicted in FIG. 7b, uses sequence b. Here, the reference signals are modulated differently. Instead of using [1 1] to modulate reference signals of both PUCCH formats, the sequences a=[a₀ a₁] and b=[b₀ b₁] are used to modulate the reference signals for PF 3b and PF 3c, respectively, with a≠b. For example, a=[1 1] could be used for PF 3b, while b=[1 −1] could be used for PF 3c. If the terminal transmits PF 3b, it uses sequence a to modulate Its reference signals, and if the terminal transmits PF 3c, it uses sequence b to modulate its reference signals.

When decoding PF 3b, the base station uses a to de-spread the reference signals, and uses b in the case of PF 3c. The base station hypothesis that matches the transmission will result in a reasonable channel estimate and a good decoding metric. The hypothesis on the de-spreading sequence that does not match the transmission will result in a completely wrong channel estimate and in a very bad decoding metric. By comparing the decoding metrics, the base station can therefore decide which format has been used, and thus also identify if the decoded bits are ACK/NACK and/or CSI.

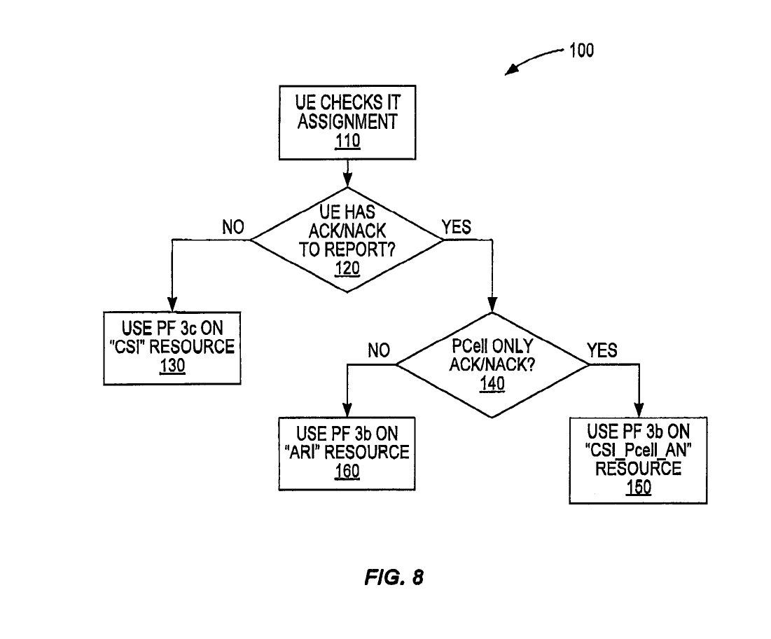

FIG. 8 depicts an exemplary method 100 implemented by the terminal (also referred to herein as the UE). After the UE checks Its assignments (block 110), the UE determines if there is an ACK/NACK to report (block 120). If there is no ACK/NACK to report, the UE uses PF 3c on the CSI resource (block 130). If there is an ACK/NACK to report, the UE determines if the ACK/NACK is a PCell only ACK/NACK (block 140). If the ACK/NACK is a PCell only ACK/NACK, the UE uses PF 3b on the CSI_PCell_AN resource (block 150). Otherwise, the UE uses PF 3b on the ARI resource (block 160).

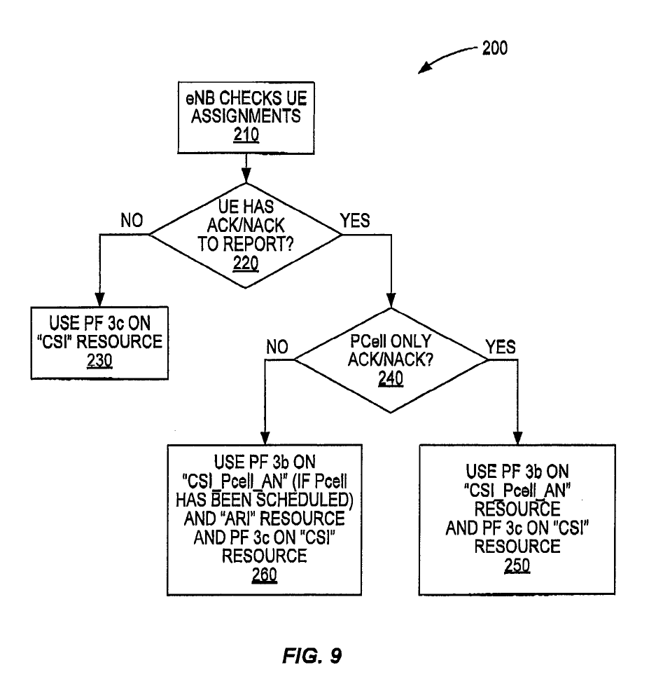

FIG. 9 depicts an exemplary method 200 implemented by the base station (also referred to herein as the eNB). After the eNB checks the UE assignments (block 210), the eNB determines if the UE has an ACK/NACK to report (block 220). If there is no ACK/NACK to report, the eNB uses PF 3c on the CSI resource (block 230). If there Is an ACK/NACK to report, the eNB determines if the ACK/NACK is a PCell only ACK/NACK (block 240). If the ACK/NACK is a PCell only ACK/NACK, the eNB uses PF 3b on the CSI_PCell_AN resource, and PF 3c on the CSI resource (block 250). Otherwise, the eNB uses PF 3b on the CSI_PCell_AN resource (if a PCELL has been scheduled) and on the ARI resource, and PF 3c on the CSI resource (block 280).

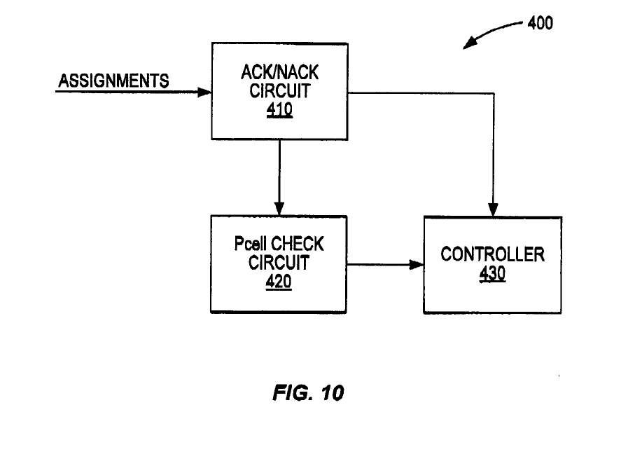

FIG. 10 is a functional block diagram of circuits 400 that may be implemented in a terminal and/or a base station. The diagram 400 includes an ACK/NACK circuit 410, a PCell check circuit 420, and a controller 430. ACK/NACK circuit 410 checks the assignments and forwards whether the terminal has an ACK/NACK to report to the PCell check circuit 420 and/or the controller 430. If there is no ACK/NACK to report, the controller 430 indicates PF 3c should be used on the CSI resource. If there is an ACK/NACK to report, the PCell check circuit 420 determines if the ACK/NACK is a PCell only ACK/NACK. If the PCell check unit 420 determines ACK/NACK Is a PCell only ACK/NACK, the controller 430 indicates PF 3b should be used on the CSI_PCell_AN resource (and if the circuit 400 is implemented in a base station controller 430 also Indicates PF 3c should be used on the CSI resource). Otherwise, controller 430 indicates PF 3b should be used on the ARI resource (and if the circuit 400 is implemented in a base station controller 430 also indicates to use PF3b on CSI_PCell AN resource (If PCELL has been scheduled) and PF 3c on the CSI resource). As used herein, a “circuit” may comprise a dedicated digital, analog, or mixed electronic circuit, or may comprise a software module executing on a processing circuit, such as a microprocessor or Digital Signal Processor (DSP).

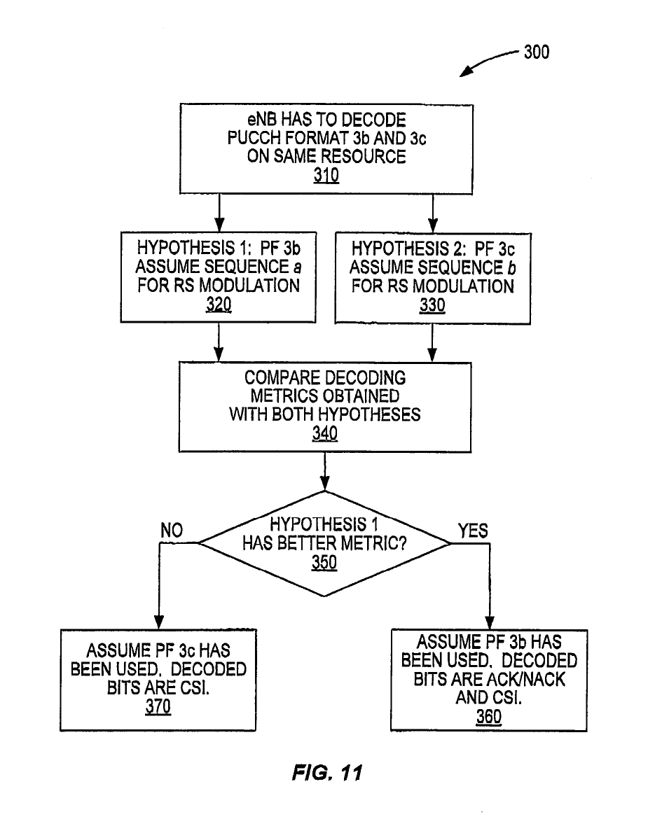

FIG. 11 depicts an exemplary method 300 implemented by the eNB for ambiguity avoidance. When the eNB has to decode the PF 3b and PF 3c on the same resource (block 310). It forms two hypotheses. In hypothesis 1, PF 3b is assumed, and a sequence a is used for RS demodulation (block 320). In hypothesis 2, PF 3c is assumed, and a sequence b is used for RS demodulation (block 330). The eNB compares the decoding metrics obtained with both hypotheses (block 340), and determines whether hypothesis 1 has a better metric (block 350). If hypothesis 1 has a better decoding metric, the eNB concludes that PF 3b has been used, and that the decoded bits are ACK/NACK and CSI (block 360). Otherwise, the eNB assumes PF 3c has been used, and that the decoded bits are CSI (block 370).

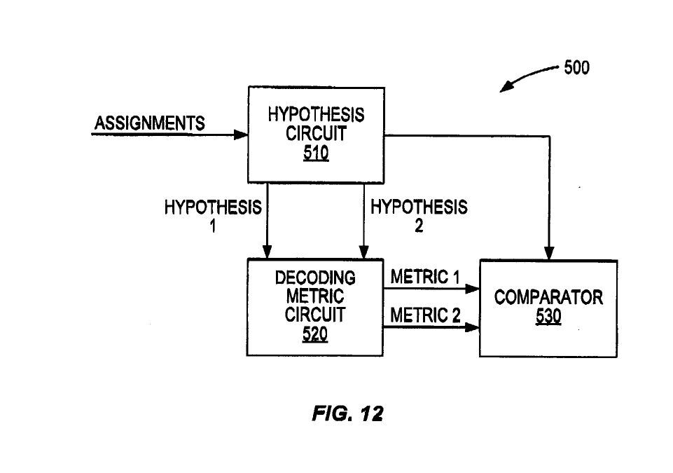

FIG. 12 is a functional block diagram of circuits 500 configured to avoid ambiguity in a base station by determining which PUCCH format was used. The diagram 500 comprises a hypothesis circuit 510, a decoding metric circuit 520, and a comparator 630. The hypothesis circuit 510 forms two hypotheses. In hypothesis 1, PF 3b Is assumed, and a sequence a is used for RS demodulation. In hypothesis 2, PF 3c Is assumed, and a sequence b is used for RS demodulation. The decoding metric circuit 520 demodulates the reference signals using the assumed sequences for each hypothesis, and outputs a decoding metric for each hypothesis. The comparator 530 compares the decoding metrics obtained with both hypotheses, and determines whether hypothesis 1 has a better metric. If hypothesis 1 has a better metric, the eNB assumes PF 3b has been used, and that the decoded bits are ACK/NACK and CSI. Otherwise, the eNB assumes PF 3c has been used, and that the decoded bits are CSI. As used herein, a “circuit” may comprise a dedicated digital, analog, or mixed electronic circuit, or may comprise a software module executing on a processing circuit, such as a microprocessor or Digital Signal Processor (DSP).

### Hardware and Software

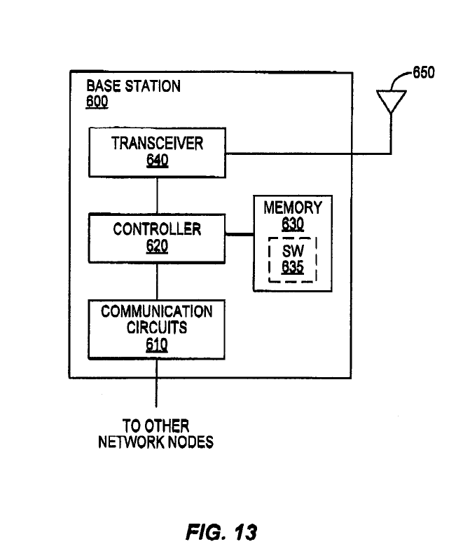

FIG. 13 depicts a base station 600 operative in embodiments of the present Invention. As those of skill in the art are aware, a base station 600 is a network node providing wireless communication services to one or more UE In a geographic region (known as a cell or sector, not to be confused with the term cell used herein to refer to component carriers in carrier aggregation, such as PCell or SCell). The base station 600 in LTE is called an e-NodeB or eNB; however the present invention is not limited to LTE or eNBs. A base station 600 includes communication circuitry 610 operative to exchange data with other network nodes; a controller 620; memory 630; and radio circuitry, such as a transceiver 640, one or more antennas 650, and the like, to effect wireless communication across an air interface to one or more UE. According to embodiments of the present invention, the memory 630 is operative to store, and the controller 620 operative to execute, software 635 which when executed is operative to cause the base station 600 to perform methods and functions described herein. In particular, the software 635 may implement a hypothesis circuit 510, decoding metric circuit 520, and/or comparator 530, as described herein with reference to FIG. 12.

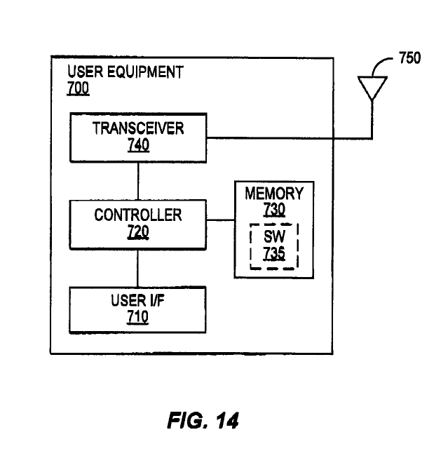

FIG. 14 depicts a UE 700 operative in embodiments of the present invention. As those of skill in the art are aware, a UE 700 is a device, which may be battery-powered and hence mobile, operative within a wireless communication network. UE 700 are also known in the art as mobile stations or mobile terminals, and may include laptop computers, pad computers, cellular radiotelephones (including “smartphones”), and the like. The UE 700 includes a user interface 710 (display, touchscreen, keyboard or keypad, microphone, speaker, and the like); a controller 720; memory 730; and a radio circuitry, such as one or more transceivers 740, antennas 760, and the like, to effect wireless communication across an air interface to one or more base stations 600. The UE 700 may additionally include features such as a camera, removable memory Interface, short-range communication interface (Wi-Fi, Bluetooth, and the like), wired interface (USB), and the like (not shown in FIG. 14). According to embodiments of the present invention, the memory 730 is operative to store, and the controller 720 operative to execute, software 735 which when executed is operative to cause the UE 700 to perform methods and functions described herein. In particular, the software 735 may Implement an ACK/NACK circuit 410, PCell check circuit 420, and/or controller 430, as described herein with reference to FIG. 10.

In all embodiments, the controller 620, 720 may comprise any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

In all embodiments, the memory 630, 730 may comprise any non-transient machine-readable media known in the art or that may be developed. Including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like.

In all embodiments, the radio circuitry may comprise one or more transceivers 640, 740 used to communicate with one or more other transceivers 640, 740 via a Radio Access Network according to one or more communication protocols known in the art or that may be developed, such as IEEE 802.xx, CDMA, WCDMA, GSM, LTE, UTRAN, WiMax, or the like. The transceiver 640, 740 implements transmitter and receiver functionality appropriate to the Radio Access Network links (e.g., frequency allocations and the like). The transmitter and receiver functions may share circuit components and/or software, or alternatively may be implemented separately. In particular, a UE 700 according to embodiments of the present invention may include a transceiver 740 having two or more sets of receiver circuits and/or two or more sets of transmitter circuits, each independently tunable to a different component carrier frequency (e.g., PCell and SCell).

In all embodiments, the communication circuitry 610 may comprise a receiver and transmitter Interface used to communicate with one or more other nodes over a communication network according to one or more communication protocols known in the art or that may be developed, such as Ethernet, TCP/IP, SONET, ATM, or the like. The communication circuitry 610 implements receiver and transmitter functionality appropriate to the communication network links (e.g., optical, electrical, and the like). The transmitter and receiver functions may share circuit components and/or software, or alternatively may be implemented separately.

The embodiments disclosed herein enable simultaneous reporting of channel state information from multiple cells. The base station always has up-to-date CSI from multiple cells, which improves DL throughput. The embodiments furthermore avoid the need to configure a terminal with both PF 2/2a/2b and PF 3 resources. Because it very difficult to reuse currently unused resources, such an avoidance is beneficial because it reduces recourse waste on the PUCCH.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are Intended to be embraced therein.

1-35. (canceled)

36. A method, performed by User Equipment (UE), operative in a wireless communication network supporting carrier aggregation, of transmitting uplink channel state information (CSI) on a Physical Uplink Control Channel (PUCCH) having first and second formats and associated with first, second, and third PUCCH resources, the method comprising:
determining any Primary Cell (PCell) and Secondary Cell (SCell) assignments;
decoding any downlink (DL) transmissions on PCell or SCell(s) and generating any corresponding Hybrid-ARQ acknowledgements; and
reporting channel state information and a Hybrid-ARQ acknowledgement on a third PUCCH resource using the first PUCCH format in response to the UE having a Hybrid-ARQ acknowledgement for one or more received SCell DL transmissions.

37. The method of claim 36 further comprising reporting channel state information on the first resource using the second PUCCH format in response to the UE having no Hybrid-ARQ acknowledgement to report.

38. The method of claim 36 further comprising reporting the Hybrid-ARQ acknowledgement on the second PUCCH resource using the first PUCCH format in response to the UE having a Hybrid-ARQ acknowledgement only for a received PCell DL transmission.

39. The method of claim 36 further comprising, for any cell on which the UE was configured but did not receive an assignment, setting a Hybrid-ARQ acknowledgement bit to negative acknowledgement (NACK) for the non-received cell assignment.

40. The method of claim 36 further comprising, if the UE received no PCell or SCell assignment, transmitting channel state information on the CSI resource using PUCCH Format 3c.

41. The method of claim 36 further comprising modulating reference signals transmitted together with the first PUCCH format with a first spreading code, and modulating reference signals transmitted together with the second PUCCH format with a different, second spreading code.

42. The method of claim 41 wherein the first spreading code is [1, 1] and the second spreading code is [1, −1].

43. The method of claim 36 wherein the first and second PUCCH resources are the same.

44. The method of claim 36 wherein the first and second PUCCH resources are specific ACK/NACK Resource Indicators.

45. The method of claim 36 wherein the first PUCCH resource is a CSI resource, the second PUCCH resource is a CSI_PCell_AN resource, and the third PUCCH resource is an ARI resource.

46. The method of claim 36 wherein the first PUCCH format is PUCCH Format 3b and the second PUCCH format is Format 3c.

47. A method, performed by a base station operative in a wireless communication network supporting carrier aggregation, of processing signals received from a User Equipment (UE) on a Physical Uplink Control Channel (PUCCH) having first and second formats and associated with first, second, and third PUCCH resources, the method comprising:
determining, from the Primary Cell (PCell) or any Secondary Cell (SCell) assignments for the UE, any corresponding expected Hybrid-ARQ acknowledgements; and
processing a Hybrid-ARQ acknowledgement on the third PUCCH resource using the first PUCCH format in response to the base station expecting a Hybrid-ARQ acknowledgement for one or more SCell downlink (DL) transmissions.

48. The method of claim 47 further comprising processing a received control signal on the first PUCCH resource using the first PUCCH format in response to the base station expecting no Hybrid-ARQ acknowledgement from the UE.

49. The method of claim 47 further comprising processing a Hybrid-ARQ acknowledgement on the second PUCCH resource using the first PUCCH format in response to the base station expecting a Hybrid-ARQ acknowledgement only for a PCell DL transmission.

50. The method of claim 47 wherein processing the signals received from the UE on a resource comprises:
forming a first hypothesis that the received signal was transmitted using the first PUCCH format and despreading reference signals using a first spreading code;
forming a second hypothesis that the received signal was transmitting using the second PUCCH format and despreading reference signals using a different, second spreading code;
decoding the signal with each hypothesis and forming decoding metrics;
comparing decoding metrics from the first and second hypotheses; and
if a decoding metric from the first hypotheses is better than a decoding metric from the second hypotheses, processing the received bits as Hybrid-ARQ acknowledgement and channel state information transmitted using the first PUCCH format.

51. The method of claim 50 further comprising, if a decoding metric from the second hypotheses is better than a decoding metric from the first hypotheses, processing the received bits as channel state information transmitted using PUCCH Format 3c.

52. The method of claim 47 further comprising checking the first PUCCH resource in response to scheduling the UE only on a PCell.

53. The method of claim 47 further comprising checking the first PUCCH resource in response to scheduling the UE on both a PCell and SCell.

54. The method of claim 47 wherein the first PUCCH resource is a CSI resource, the second PUCCH resource is a CSI_PCell_AN resource, and the third PUCCH resource is an ARI resource.

55. The method of claim 47 wherein the first PUCCH format is PUCCH Format 3b and the second PUCCH format is Format 3c.

56. A User Equipment (UE) configured to operate in a wireless communication network supporting carrier aggregation, and to transmit uplink channel state information (CSI) on a Physical Uplink Control Channel (PUCCH) having first and second formats and associated with first, second, and third PUCCH resources, the UE comprising:
a transceiver;
memory; and
a controller operatively connected to the transceiver and the memory, the controller operative to:
determine any Primary Cell (PCell) and Secondary Cell (SCell) assignments;
decode any downlink (DL) transmissions on PCell or SCell(s) and generate any corresponding Hybrid-ARQ acknowledgements; and
cause the transceiver to report channel state information and a Hybrid-ARQ acknowledgement on the third PUCCH resource using the first PUCCH format in response to the UE having a Hybrid-ARQ acknowledgement to report for one or more received SCell DL transmissions.

57. The UE of claim 56 wherein the controller is further operative to cause the transceiver to report channel state information on the first PUCCH resource using the first PUCCH format in response to the UE having no Hybrid-ARQ acknowledgement to report.

58. The UE of claim 56 wherein the controller is further operative to cause the transceiver to report a Hybrid-ARQ acknowledgement on the second PUCCH resource using the first PUCCH format in response to the UE having a Hybrid-ARQ acknowledgement to report only for a received PCell DL transmission.

59. The UE of claim 56 wherein the controller is further operative to, for any cell on which the UE was configured but did not receive an assignment, set a Hybrid-ARQ acknowledgement bit to negative acknowledgement (NACK) for the non-received cell assignments.

60. The UE of claim 56 wherein the controller is further operative to cause the transceiver to report a Hybrid-ARQ acknowledgement bit on the second PUCCH resource using the first PUCCH format, setting the Hybrid-ARQ acknowledgement bit to negative acknowledgement (NACK) for a non-received SCell assignments in response to the UE being scheduled on one or more SCells but receiving only a PCell assignment.

61. The UE of claim 56 wherein the controller is further operative to cause the transceiver to transmit channel state information on the first PUCCH resource using the second PUCCH format in response to the UE receiving no valid PCell or SCell assignment.

62. The UE of claim 56 wherein the controller is further operative to modulate reference signals transmitted together with the first PUCCH format with a first spreading code, and modulate reference signals transmitted together with second PUCCH format with a different, second spreading code.

63. The UE of claim 62 wherein the first spreading code is [1, 1] and the second spreading code is [1, −1].

64. The UE of claim 56 wherein the first and second PUCCH resources are the same.

65. The UE of claim 56 wherein the first and second PUCCH resources are specific ACK/NACK Resource Indicators.

66. A base station configured to operate in a wireless communication network supporting carrier aggregation and to process signals received from a User Equipment (UE) on a Physical Uplink Control Channel (PUCCH) having first and second formats and associated with first, second, and third PUCCH resources, the base station comprising:
communication circuits operative to communicate with other network nodes;
a transceiver;
memory; and
a controller operatively connected to the communication circuits, the transceiver, and the memory, the controller operative to:
determine, from Primary Cell (PCell) and any Secondary Cell (SCell) assignments for the UE, any corresponding expected Hybrid-ARQ acknowledgements; and
process a Hybrid-ARQ acknowledgement on an ARI resource using the first PUCCH format in response to the base station expecting a Hybrid-ARQ acknowledgement for one or more SCell downlink (DL) transmissions.

67. The base station of claim 66 wherein the controller is further operative to process a channel state information report on the first PUCCH resource using the second PUCCH format in response to the base station expecting no Hybrid-ARQ acknowledgement from the UE.

68. The base station of claim 66 wherein the controller is further operative to process a Hybrid-ARQ acknowledgement on the second PUCCH resource using the first PUCCH format in response to the base station expecting a Hybrid-ARQ acknowledgement only for a PCell DL transmission.

69. The base station of claim 66 wherein the controller is operative to process a received signal on a resource by:
forming a first hypothesis that the received signal was transmitting using the first PUCCH format and despreading reference signals using a first spreading code;
forming a second hypothesis that the received signal was transmitting using the second PUCCH format and despreading reference signals using a different, second spreading code;
decoding the signal with each hypothesis and forming decoding metrics;
comparing decoding metrics from the first and second hypotheses; and
if a decoding metric from the first hypothesis is better than a decoding metric from the second hypothesis, processing the received bits as Hybrid-ARQ acknowledgement and channel state information transmitted using the first PUCCH format.

70. The base station of claim 69 wherein the controller is operative to, if a decoding metric from the second hypothesis is better than a decoding metric from the first hypothesis, process the received bits as channel state information transmitted using the second PUCCH format.

71. The base station of claim 66 wherein the controller is further operative to check the first PUCCH resource in response to scheduling the UE only on a PCell.

72. The base station of claim 66 wherein the controller is further operative to check the first PUCCH resource in response to scheduling the UE on both a PCell and SCell.
